(19) United States
(12) Patent Application Publication
(10) Pub. No.: US 2026/0235508 A1
(43) Pub. Date: Aug. 13, 2026

(54) TERAHERTZ WAVE SPECTROSCOPIC MEASUREMENT APPARATUS AND TERAHERTZ WAVE SPECTROSCOPIC MEASUREMENT METHOD

(71) Applicant: HAMAMATSU PHOTONICS K.K., Hamamatsu-shi (JP)

(72) Inventors: Hisanari TAKAHASHI, Shizuoka (JP); Yasunaga NARA, Shizuoka (JP); Ginji SUGIURA, Shizuoka (JP)

(73) Assignee: HAMAMATSU PHOTONICS K.K., Hamamatsu-shi (JP)

(21) Appl. No.: 19/532,970

(22) Filed: Feb. 6, 2026

(30) Foreign Application Priority Data
Feb. 10, 2025 (JP) 2025-019720

(51) Int. Cl. G01N 21/3586; G01N 21/23

(52) U.S. Cl. CPC G01N 21/3586; G01N 21/23

(57) ABSTRACT

A terahertz wave spectroscopic measurement apparatus includes a pump light source, a terahertz wave generation element, a terahertz wave detection element, a probe light source, a quarter wave plate, a polarizing beam splitter, a streak camera, a timing generation unit, and an analysis unit, and is configured to perform spectroscopic measurement of a sample. The streak camera detects temporal waveforms of respective intensities of a first polarized light component and a second polarized light component of probe light output from the polarizing beam splitter and of pump light. The analysis unit performs the spectroscopic measurement of the sample based on the temporal waveforms detected by the streak camera.

### CROSS-REFERENCE TO RELATED APPLICATION

This application is based upon and claims the benefit of priority from Japanese Patent Application No. 2025-019720, filed on February 10, 2025, the entire contents of which are incorporated herein by reference.

### TECHNICAL FIELD

The present disclosure relates to a terahertz wave spectroscopic measurement apparatus and a terahertz wave spectroscopic measurement method for performing spectroscopic measurement by using a terahertz wave.

### BACKGROUND

A terahertz wave is an electromagnetic wave in a frequency region of about 0.1 THz to 10 THz, and is suitably used to acquire information on a molecular structure of a sample. As a technique for performing spectroscopic measurement by using a terahertz wave, terahertz time domain spectroscopy (THz-TDS) is known (Non Patent Document 1).

In the THz-TDS, a terahertz wave is generated by inputting pulsed light of an ultrashort pulse to a terahertz wave generation element, a sample is irradiated with the terahertz wave, and the terahertz wave passed through the sample and the pulsed light are input to a terahertz wave detection element. The incident timing of the terahertz wave is scanned with respect to the incident timing of the pulsed light into the terahertz wave detection element.

Further, by measuring a difference between respective intensities of two polarized light components orthogonal to each other of the pulsed light output with polarization modulation by the terahertz wave detection element by using a lock-in amplifier, and analyzing the measurement result, a complex refractive index of the sample in a terahertz wave region can be obtained.

However, in the conventional THz-TDS described above, it is necessary to scan the incident timing of the terahertz wave with respect to the incident timing of the pulsed light into the terahertz wave detection element, and further, it is also necessary to measure, by using the lock-in amplifier, the difference between the respective intensities of the two polarized light components orthogonal to each other of the pulsed light output from the terahertz wave detection element, and thus, the measurement requires a long time.

A technique of measuring a temporal waveform of an intensity of a terahertz wave by using a streak camera is also known (Non Patent Document 2). In this technique, a terahertz wave is generated by inputting pulsed light of an ultrashort pulse to a terahertz wave generation element, the terahertz wave is input to a terahertz wave detection element, and further, probe light generated by stretching a pulse width of the pulsed light is also input to the terahertz wave detection element.

Further, a temporal waveform of the probe light output with polarization modulation by the terahertz wave detection element is detected by using the streak camera, and the temporal waveform of the intensity of the terahertz wave is obtained from the detection result. The above technique can obtain the temporal waveform of the intensity of the terahertz wave in a single shot. The above technique does not perform the spectroscopic measurement of the sample.

Non Patent Document 1: Ajay Nahata et al., "A wideband coherent terahertz spectroscopy system using optical rectification and electro-optic sampling", Appl. Phys. Lett., Vol.69, pp.2321-2323, 1996

Non Patent Document 2: Zhiping Jiang et al., "Terahertz pulse measurement with an optical streak camera", OPTICS LETTERS, Vol.24, No.17, pp.1245-1247, 1999

Non Patent Document 3: Ryo Tamaki et al., “Pulse-to-pulse detection of terahertz radiation emitted from the femtosecond laser ablation process", Optics Express, Vol.30, No.13, pp.23622-23630, 2022

### SUMMARY

The present inventors have made intensive studies to solve the above problem that the conventional THz-TDS requires a long time for performing the spectroscopic measurement, and in the course of the studies, the present inventors attempted to use the streak camera. However, the present inventors have found that it is difficult to perform the spectroscopic measurement of the sample by simply using the streak camera in place of scanning of the timing and use of the lock-in amplifier in the conventional THz-TDS.

An object of the present invention is to provide a terahertz wave spectroscopic measurement apparatus and a terahertz wave spectroscopic measurement method capable of performing spectroscopic measurement of a sample by using a terahertz wave in a short time.

An embodiment of a first aspect of the present invention is a terahertz wave spectroscopic measurement apparatus. The terahertz wave spectroscopic measurement apparatus includes (1) a pump light source configured to output pulsed light as pump light; (2) a terahertz wave generation element configured to input the pump light, and generate a terahertz wave; (3) a terahertz wave detection element configured to input the terahertz wave passed through a sample, input probe light over an input period of the terahertz wave, and output the probe light with polarization modulation according to an electric field of the terahertz wave; (4) a quarter wave plate configured to change a polarization state of the probe light output from the terahertz wave detection element; (5) a polarizing beam splitter configured to split the probe light output from the quarter wave plate into a first polarized light component and a second polarized light component orthogonal to each other; (6) a streak camera configured to detect temporal waveforms of respective intensities of the first polarized light component and the second polarized light component of the probe light output from the polarizing beam splitter and of the pump light; and (7) an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

An embodiment of a second aspect of the present invention is a terahertz wave spectroscopic measurement apparatus. The terahertz wave spectroscopic measurement apparatus includes (1) a pump light source configured to output pulsed light as pump light; (2) a terahertz wave detection element configured to input a terahertz wave generated when a sample is processed by irradiating the sample with the pump light, input probe light over an input period of the terahertz wave, and output the probe light with polarization modulation according to an electric field of the terahertz wave; (3) a quarter wave plate configured to change a polarization state of the probe light output from the terahertz wave detection element; (4) a polarizing beam splitter configured to split the probe light output from the quarter wave plate into a first polarized light component and a second polarized light component orthogonal to each other; (5) a streak camera configured to detect temporal waveforms of respective intensities of the first polarized light component and the second polarized light component of the probe light output from the polarizing beam splitter and of the pump light; and (6) an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitor a processing status of the sample.

An embodiment of a first aspect of the present invention is a terahertz wave spectroscopic measurement method. The terahertz wave spectroscopic measurement method includes (1) a terahertz wave generation step of inputting pulsed light output as pump light from a pump light source to a terahertz wave generation element, and generating a terahertz wave by the terahertz wave generation element; (2) a modulation step of inputting the terahertz wave passed through a sample to a terahertz wave detection element, inputting probe light to the terahertz wave detection element over an input period of the terahertz wave, and outputting the probe light with polarization modulation according to an electric field of the terahertz wave by the terahertz wave detection element; (3) a polarized light splitting step of splitting, by a polarizing beam splitter, the probe light output from the terahertz wave detection element and passed through a quarter wave plate into a first polarized light component and a second polarized light component orthogonal to each other; (4) a temporal waveform detection step of detecting, by a streak camera, temporal waveforms of respective intensities of the first polarized light component and the second polarized light component of the probe light output from the polarizing beam splitter and of the pump light; and (5) an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

An embodiment of a second aspect of the present invention is a terahertz wave spectroscopic measurement method. The terahertz wave spectroscopic measurement method includes (1) a terahertz wave generation step of irradiating a sample with pulsed light output as pump light from a pump light source, and generating a terahertz wave when the sample is processed; (2) a modulation step of inputting the terahertz wave to a terahertz wave detection element, inputting probe light to the terahertz wave detection element over an input period of the terahertz wave, and outputting the probe light with polarization modulation according to an electric field of the terahertz wave by the terahertz wave detection element; (3) a polarized light splitting step of splitting, by a polarizing beam splitter, the probe light output from the terahertz wave detection element and passed through a quarter wave plate into a first polarized light component and a second polarized light component orthogonal to each other; (4) a temporal waveform detection step of detecting, by a streak camera, temporal waveforms of respective intensities of the first polarized light component and the second polarized light component of the probe light output from the polarizing beam splitter and of the pump light; and (5) an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitoring a processing status of the sample.

According to the terahertz wave spectroscopic measurement apparatus and the terahertz wave spectroscopic measurement method of the embodiments of the present invention, it is possible to perform spectroscopic measurement of a sample by using a terahertz wave in a short time.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram illustrating a configuration of a terahertz wave spectroscopic measurement apparatus 9 according to a comparative example.

FIG. 2 is a diagram showing an example of a relationship between a difference of respective intensities of a first polarized light component and a second polarized light component of probe light output from a polarizing beam splitter 16 and a timing difference.

FIG. 3A and FIG. 3B are diagrams each showing a result of detecting a temporal waveform of an intensity of pulsed light output from a pulsed light source by using a streak camera.

FIG. 4A to FIG. 4C are diagrams each showing a result of detecting a temporal waveform of an intensity of each of the first polarized light component and the second polarized light component of the probe light output from the polarizing beam splitter 16 by using the streak camera.

FIG. 5 is a diagram showing a difference between respective intensities of the first polarized light component and the second polarized light component of the probe light obtained based on the detection results by the streak camera shown in FIG. 4A to FIG. 4C.

FIG. 6 is a diagram illustrating a configuration of a terahertz wave spectroscopic measurement apparatus 1 according to a first embodiment.

FIG. 7 is a diagram schematically illustrating a phosphor image displayed on a phosphor screen of a streak camera 17.

FIG. 8 is a diagram illustrating a configuration of a terahertz wave spectroscopic measurement apparatus 2 according to a second embodiment.

FIG. 9 is a diagram illustrating a configuration of a terahertz wave spectroscopic measurement apparatus 3 according to a third embodiment.

### DETAILED DESCRIPTION

Hereinafter, embodiments of a terahertz wave spectroscopic measurement apparatus and a terahertz wave spectroscopic measurement method will be described in detail with reference to the accompanying drawings. In the description of the drawings, the same elements will be denoted by the same reference signs, and redundant description will be omitted. The present invention is not limited to these examples, and the claims, their equivalents, and all the changes within the scope are intended as would fall within the scope of the present invention.

First, a configuration of a terahertz wave spectroscopic measurement apparatus according to a comparative example will be described, and thereafter, a configuration of a terahertz wave spectroscopic measurement apparatus according to an embodiment will be described.

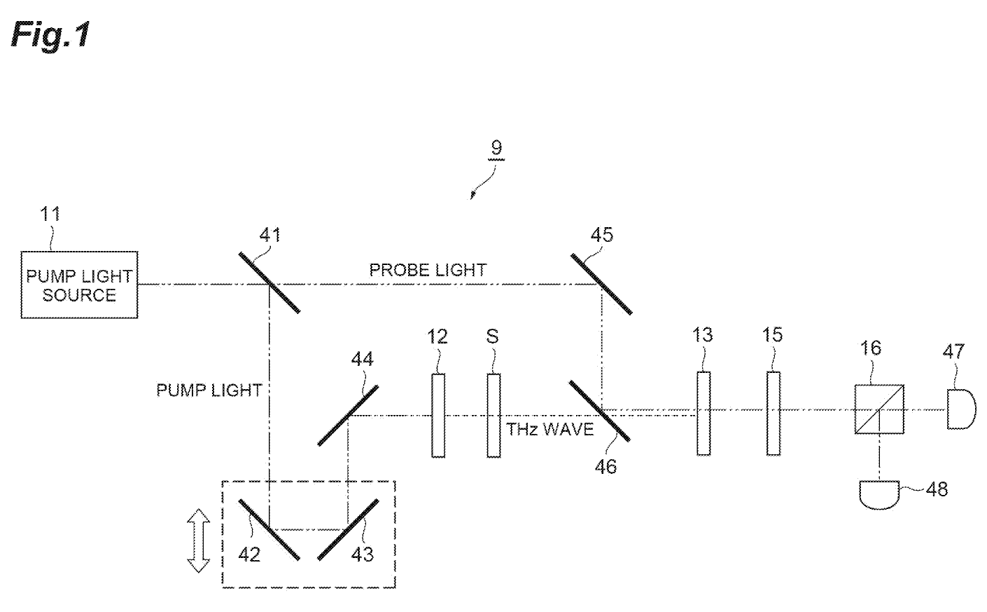

FIG. 1 is a diagram illustrating a configuration of a terahertz wave spectroscopic measurement apparatus 9 according to a comparative example. The terahertz wave spectroscopic measurement apparatus 9 includes a pump light source 11, a terahertz wave generation element 12, a terahertz wave detection element 13, a quarter wave plate 15, and a polarizing beam splitter 16, and the like, and performs spectroscopic measurement of a sample S which is placed on an optical path of a terahertz wave between the terahertz wave generation element 12 and the terahertz wave detection element 13.

Pulsed light output from the pump light source 11 is split into two light beams by a beam splitter 41, one pulsed light is output to a mirror 42 as pump light, and the other pulsed light is output to a mirror 45 as probe light.

The pump light output from the beam splitter 41 to the mirror 42 is sequentially reflected by mirrors 42 to 44, and is input to the terahertz wave generation element 12. By inputting the pump light to the terahertz wave generation element 12, a terahertz wave is generated from the terahertz wave generation element 12. After being passed through the sample S, the terahertz wave is transmitted through a beam combining mirror 46, and is input to the terahertz wave detection element 13.

The probe light output from the beam splitter 41 to the mirror 45 is sequentially reflected by the mirror 45 and the beam combining mirror 46, and is input to the terahertz wave detection element 13.

The terahertz wave detection element 13 inputs the terahertz wave passed through the sample S, and further, inputs the probe light. The terahertz wave detection element 13 outputs the probe light with polarization modulation according to an electric field of the input terahertz wave.

The quarter wave plate 15 inputs the probe light output from the terahertz wave detection element 13, changes a polarization state of the probe light, and outputs the probe light. The polarizing beam splitter 16 inputs the probe light output from the quarter wave plate 15, and splits the probe light into a first polarized light component and a second polarized light component orthogonal to each other.

A first photodetector 47 detects an intensity of the first polarized light component of the probe light output from the polarizing beam splitter 16. A second photodetector 48 detects an intensity of the second polarized light component of the probe light output from the polarizing beam splitter 16. An orientation of an optic axis of the quarter wave plate 15 is set such that, in the case in which the sample S is not provided, respective detection results of the first photodetector 47 and the second photodetector 48 are to be equal to each other.

The mirrors 42 and 43 provided on an optical path of the pump light are movable integrally in a direction indicated by a double arrow in the diagram. By the above movement, the incident timing of the terahertz wave is scanned with respect to the incident timing of the probe light into the terahertz wave detection element 13.

Further, the respective detection results of the first photodetector 47 and the second photodetector 48 are input to a lock-in amplifier, and a difference between the respective intensities of the first polarized light component and the second polarized light component of the probe light output from the polarizing beam splitter 16 is obtained. By analyzing the above result, a complex refractive index of the sample S in the terahertz wave region can be obtained, and the spectroscopic measurement of the sample S can be performed.

In the configuration of the comparative example described above, it is necessary to scan the incident timing of the terahertz wave with respect to the incident timing of the probe light into the terahertz wave detection element 13 by mechanically moving the mirrors 42 and 43. Further, it is also necessary to measure, by using the lock-in amplifier, the difference between the respective intensities of the first polarized light component and the second polarized light component of the probe light output from the polarizing beam splitter 16. For these reasons, the measurement requires a long time.

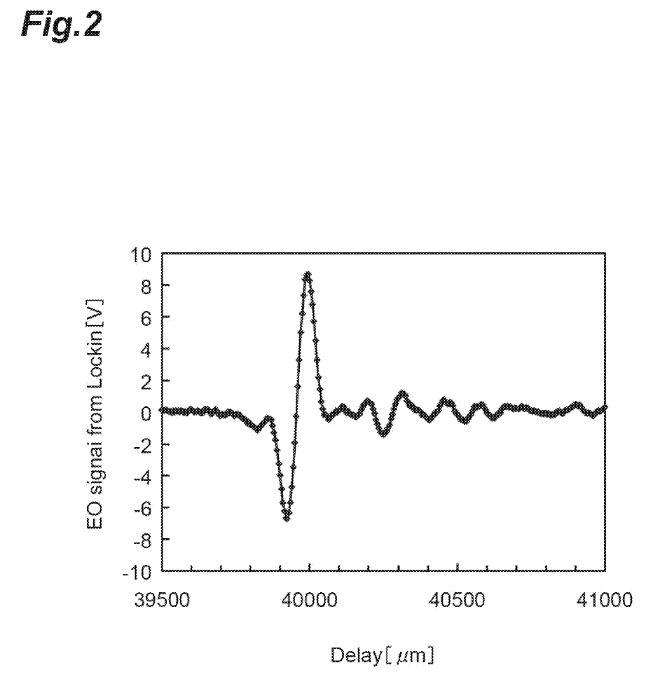

FIG. 2 is a diagram showing an example of a relationship between a difference of respective intensities of the first polarized light component and the second polarized light component of the probe light output from the polarizing beam splitter 16, and a timing difference. The horizontal axis indicates, as a movement amount (unit: μm) of the mirrors 42 and 43, the difference between the incident timing of the probe light and the incident timing of the terahertz wave into the terahertz wave detection element 13. The vertical axis indicates the result obtained by the lock-in amplifier for the difference between the respective intensities of the first polarized light component and the second polarized light component of the probe light output from the polarizing beam splitter 16. In order to obtain the above data, it is necessary to sequentially set the difference between the incident timing of the probe light and the incident timing of the terahertz wave into the terahertz wave detection element 13 to a large number of respective values, and thus, a long time is required.

In order to solve the above problem, the present inventors considered, for example, using CW light as the probe light to be input to the terahertz wave detection element 13, detecting a temporal waveform of an intensity of each of the first polarized light component and the second polarized light component of the probe light output from the polarizing beam splitter 16 by using a streak camera, and analyzing the above two temporal waveforms to determine the complex refractive index of the sample S.

However, the present inventors have found that it is difficult to perform the spectroscopic measurement of the sample by simply using the streak camera in place of scanning of the timing and use of the lock-in amplifier in the configuration of the comparative example. Further, the present inventors conducted further intensive studies, and completed the present invention. This will be described next.

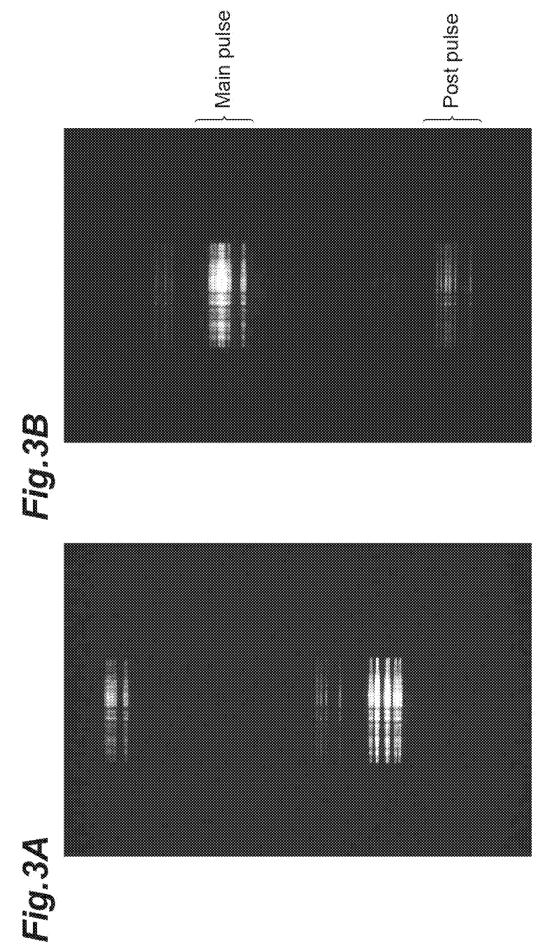

FIG. 3A and FIG. 3B are diagrams showing the results of detecting the temporal waveform of the intensity of the pulsed light output from the pulsed light source by using the streak camera. Each of FIG. 3A and FIG. 3B shows a phosphor image (a streak image) displayed on a phosphor screen of the streak camera. The vertical direction corresponds to the temporal axis, and the range of the temporal axis is set to 10 ns. The horizontal direction corresponds to the spatial axis.

A trigger signal for starting detection of the temporal waveform of the pulsed light intensity in the streak camera is generated in synchronization with a trigger signal for causing pulsed light emission in the pulsed light source. FIG. 3A and FIG. 3B show the detection results of a plurality of pulses in periods different from each other.

As shown in FIG. 3A and FIG. 3B, the detection results of the temporal waveform of the pulsed light intensity are different for each pulse, and lack reproducibility. It is considered that the cause of the above is jitter in the pulsed light source and jitter in a circuit used for generating the trigger signal supplied to the streak camera. Further, as shown in these diagrams, in addition to an original temporal waveform of the pulsed light intensity (a main pulse), a post pulse appears separately. For these reasons, it is difficult to perform the spectroscopic measurement of the sample by simply using the streak camera.

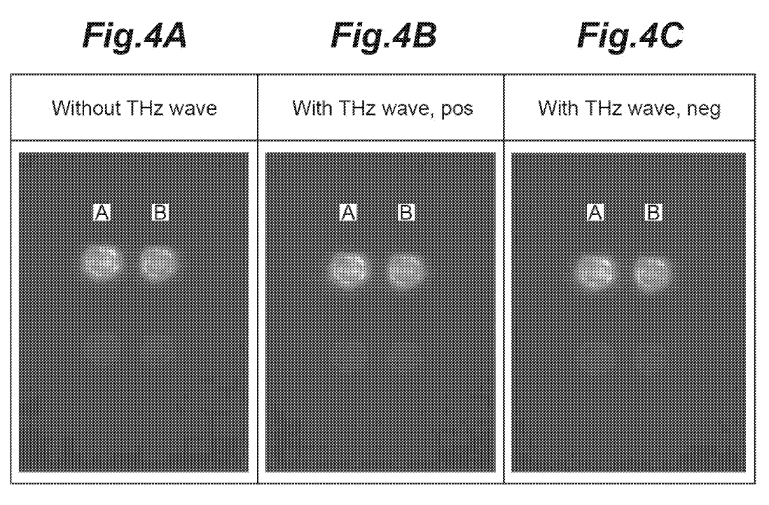

FIG. 4A to FIG. 4C are diagrams showing the results of detecting the temporal waveform of the intensity of each of the first polarized light component and the second polarized light component of the probe light output from the polarizing beam splitter 16 by using the streak camera. Each of FIG. 4A to FIG. 4C shows the phosphor image (the streak image) displayed on the phosphor screen of the streak camera. The vertical direction corresponds to the temporal axis, and the horizontal direction corresponds to the spatial axis.

These diagrams are obtained by using the streak camera in place of the photodetectors 47 and 48 in the configuration of the comparative example illustrated in FIG. 1, and by causing each of the first polarized light component and the second polarized light component of the probe light output from the polarizing beam splitter 16 to be incident into the streak camera. In each of FIG. 4A to FIG. 4C, A represents the temporal waveform of the first polarized light component, and B represents the temporal waveform of the second polarized light component.

FIG. 4A is the phosphor image in the case in which the terahertz wave is not input to the terahertz wave detection element 13. Each of FIG. 4B and FIG. 4C is the phosphor image in the case in which the terahertz wave is input to the terahertz wave detection element 13.

In FIG. 4B and FIG. 4C, the difference between the incident timing of the probe light and the incident timing of the terahertz wave into the terahertz wave detection element 13 is different. FIG. 4B is the phosphor image in the case in which the incident timing difference is set to a value at which the difference between the respective intensities of the first polarized light component and the second polarized light component of the probe light becomes maximum in FIG. 2. FIG. 4C is the phosphor image in the case in which the incident timing difference is set to a value at which the difference between the respective intensities of the first polarized light component and the second polarized light component of the probe light becomes minimum in FIG. 2.

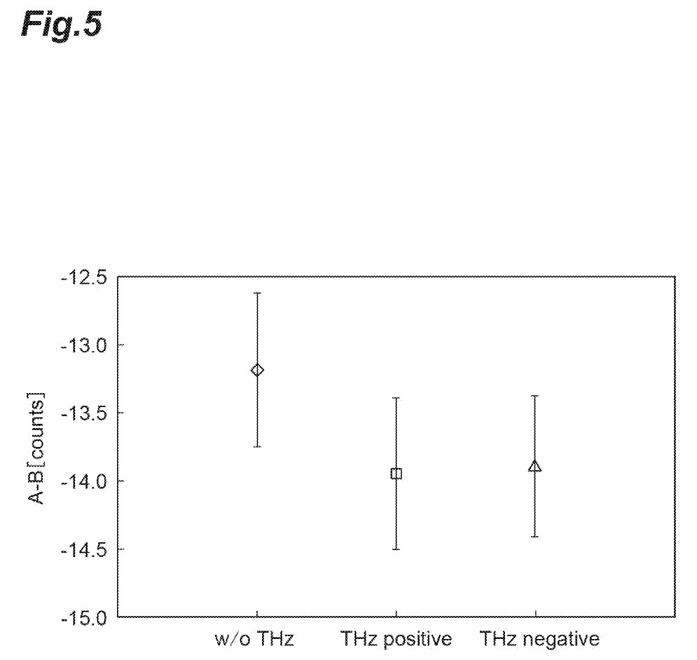

FIG. 5 is a diagram showing the difference between the respective intensities of the first polarized light component and the second polarized light component of the probe light obtained based on the detection results by using the streak camera shown in FIG. 4A to FIG. 4C. As shown in this diagram, as compared with the case in which the terahertz wave is not input to the terahertz wave detection element 13, in the case in which the terahertz wave is input to the terahertz wave detection element 13, the difference between the respective intensities of the first polarized light component and the second polarized light component of the probe light is significantly different.

A terahertz wave spectroscopic measurement apparatus and a terahertz wave spectroscopic measurement method of an embodiment described below are based on the findings of the present inventors as described above.

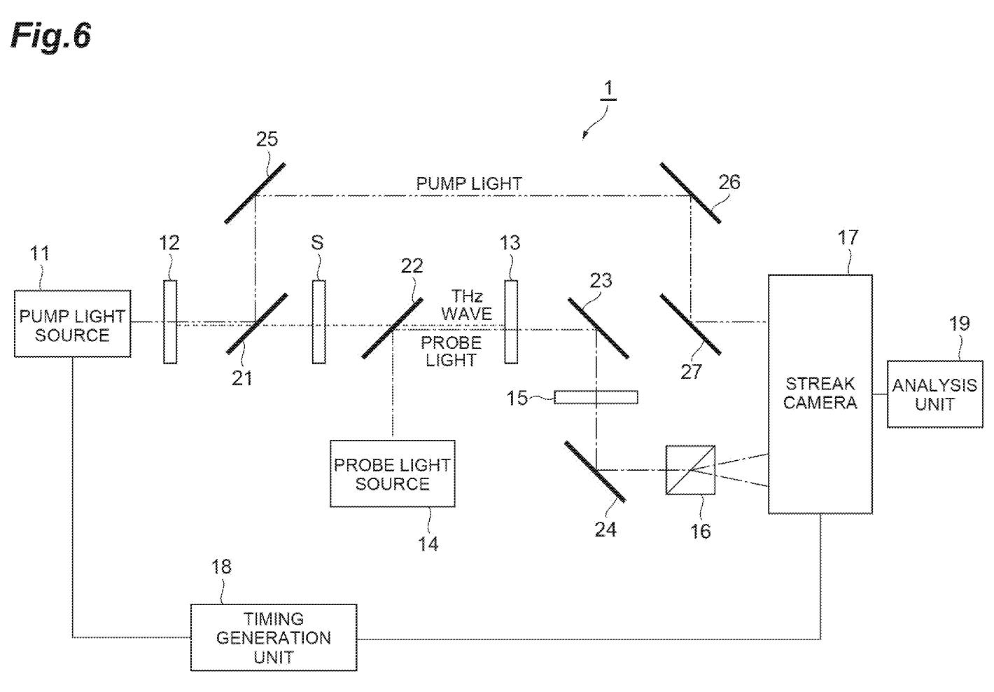

FIG. 6 is a diagram illustrating a configuration of a terahertz wave spectroscopic measurement apparatus 1 according to a first embodiment. The terahertz wave spectroscopic measurement apparatus 1 includes the pump light source 11, the terahertz wave generation element 12, the terahertz wave detection element 13, a probe light source 14, the quarter wave plate 15, the polarizing beam splitter 16, a streak camera 17, a timing generation unit 18, an analysis unit 19, and the like, and performs the spectroscopic measurement of the sample S which is placed on the optical path of the terahertz wave between the terahertz wave generation element 12 and the terahertz wave detection element 13.

The pump light source 11 outputs the pulsed light as the pump light, and is preferably a femtosecond laser light source for outputting the pump light of the ultrashort pulse having a pulse width of 100 ps or less.

Examples of the femtosecond laser light source include a titanium sapphire laser light source for outputting the pump light of a wavelength of 800 nm, an optical fiber laser light source including an optical fiber doped with an erbium element (Er) as an amplification medium and for outputting the pump light of a wavelength of 1550 nm, an optical fiber laser light source including an optical fiber doped with a ytterbium element (Yb) as an amplification medium and for outputting the pump light of a wavelength of 1030 nm, and an optical fiber laser light source including an optical fiber doped with a thulium element (Tm) as an amplification medium and for outputting the pump light of a wavelength of 2000 nm.

The terahertz wave generation element 12 inputs the pump light output from the pump light source 11, and generates the terahertz wave. The terahertz wave detection element 13 inputs the terahertz wave output from the terahertz wave generation element 12 and passed through the sample S, and in addition, inputs the probe light output from the probe light source 14 over an input period of the terahertz wave. The terahertz wave detection element 13 outputs the probe light with the polarization modulation according to the electric field of the input terahertz wave. The terahertz wave may be transmitted through the sample S, may be reflected by the sample S, or may be totally reflected at a surface of the sample S.

As each of the terahertz wave generation element 12 and the terahertz wave detection element 13, for example, inorganic crystals such as ZnTe, GaP, GaSe, and the like, and organic crystals such as DAST (4-dimethylamino-N-methyl-4-stilbazolium tosylate), DASC (4-N,N-dimethylamino-4'-N'-methylstilbazolium tosylate), and the like, are used. It is preferable that the organic crystal is used as each of the terahertz wave generation element 12 and the terahertz wave detection element 13.

The probe light source 14 outputs the probe light such that, over the period in which the terahertz wave is input to the terahertz wave detection element 13, the probe light is also input to the terahertz wave detection element 13. The probe light source 14 may be, for example, a He-Ne laser light source or a semiconductor laser light source.

A wavelength of the probe light is preferably set to 800 nm or less at which sensitivity of the streak camera 17 is high. Further, from a viewpoint of phase matching in the terahertz wave detection element 13, it is preferable that a difference Δn between a refractive index at the terahertz wave and a phase refractive index at the probe light wavelength is small (for example, Δn < 0.1), and thus, the probe light preferably has a wavelength which satisfies the above relationship.

For example, in the case in which the ZnTe crystal is used as the terahertz wave detection element 13, the probe light wavelength is more preferably 800 nm or less and 550 nm or more at which absorption of the crystal is small. In the case in which the organic crystal such as DAST is used as the terahertz wave detection element 13, it is sufficient to use the streak camera 17 having the sensitivity on a long wavelength side. The probe light may be the CW light, or may be the pulsed light. In terms of heat suppression, it is preferable that the probe light is set to the pulsed light.

A beam separating mirror 21 which is provided on an optical path between the terahertz wave generation element 12 and the sample S inputs the terahertz wave generated in the terahertz wave generation element 12, and transmits the terahertz wave to the sample S, and further, inputs the pump light transmitted through the terahertz wave generation element 12, and reflects the pump light to a mirror 25.

A beam combining mirror 22 which is provided on an optical path between the sample S and the terahertz wave detection element 13 inputs the terahertz wave passed through the sample S, and transmits the terahertz wave to the terahertz wave detection element 13, and further, inputs the probe light output from the probe light source 14, and reflects the probe light to the terahertz wave detection element 13. The terahertz wave and the probe light output from the beam combining mirror 22 and input to the terahertz wave detection element 13 are made coaxial.

A beam separating mirror 23 which is provided at the subsequent stage of the terahertz wave detection element 13 inputs the probe light output with the polarization modulation by the terahertz wave detection element 13, and reflects the probe light to the quarter wave plate 15. In the case in which there is the terahertz wave transmitted through and output from the terahertz wave detection element 13, the beam separating mirror 23 inputs and transmits the above terahertz wave. From the terahertz wave detection element 13 to the quarter wave plate 15, out of the probe light and the terahertz wave, the probe light is selectively input.

Each of the beam separating mirror 21, the beam combining mirror 22, and the beam separating mirror 23 is preferably a pellicle having high transmittance for the terahertz wave and high reflectance for the pump light and the probe light. In particular, a material of the pellicle is preferably kapton or a silicon nitride membrane. Further, each of the beam separating mirror 21, the beam combining mirror 22, and the beam separating mirror 23 may be a high resistance silicon wafer (resistivity > 100 Ωcm) which reflects the pump light and the probe light and transmits about 50% of the terahertz wave.

The quarter wave plate 15 inputs the probe light output from the terahertz wave detection element 13 and passed through the beam separating mirror 23, changes the polarization state of the probe light, and outputs the probe light. The polarizing beam splitter 16 inputs the probe light output from the quarter wave plate 15 and reflected by a mirror 24, splits the probe light into the first polarized light component and the second polarized light component orthogonal to each other, and outputs to the streak camera 17.

The orientation of the optic axis of the quarter wave plate 15 is set such that, in the case in which the sample S is not provided, the respective intensities of the first polarized light component and the second polarized light component of the probe light output from the polarizing beam splitter 16 are to be equal to each other. By setting the orientation of the optic axis of the quarter wave plate 15 as described above, when the sample S is inserted, the difference between the respective intensities of the first polarized light component and the second polarized light component of the probe light output from the polarizing beam splitter 16 can be made large, and it becomes possible to perform the spectroscopic measurement with high sensitivity.

The pump light which is reflected by the beam separating mirror 21 is sequentially reflected by mirrors 25 to 27, and input to the streak camera 17.

The streak camera 17 detects temporal waveforms of the respective intensities of the first polarized light component and the second polarized light component of the probe light output from the polarizing beam splitter 16. Further, the streak camera 17 also detects a temporal waveform of the intensity of the pump light. A temporal resolution of the streak camera 17 is preferably 5 ps or less, and more preferably 1 ps or less.

The streak camera includes a slit, a lens, a photocathode, an accelerating electrode, a sweep electrode, an electron multiplier unit, and a phosphor screen. The light incident on the slit of the streak camera passes through the slit, and forms an image on the photocathode by the lens. At the photocathode, electrons are emitted with the number according to the light intensity. The electrons emitted from the photocathode are accelerated by the accelerating electrode, and then deflected by the sweep electrode, and input to the electron multiplier unit. The electrons whose number is multiplied by the electron multiplier unit are incident on the phosphor screen, and a phosphor image (a streak image) is displayed on the phosphor screen.

A voltage is applied to the sweep electrode in a direction perpendicular to a longitudinal direction of the slit, and the applied voltage value is swept over time. By the sweep of the voltage value applied to the sweep electrode, the phosphor image displayed on the phosphor screen becomes an image representing the temporal waveform of the intensity of the incident light. The temporal waveforms of the intensities of light beams incident at positions different from each other in the longitudinal direction of the slit are displayed at positions different from each other on the phosphor screen.

On the phosphor screen, one certain direction represents the position in the longitudinal direction of the slit, and a direction perpendicular to the one direction represents a time of light incidence into the slit. The streak camera described above is manufactured and sold by Hamamatsu Photonics K.K.

The timing generation unit 18 generates the trigger signal for indicating a start timing of the voltage sweep at the sweep electrode of the streak camera 17, and supplies the trigger signal to the streak camera 17. Further, the timing generation unit 18 may input the trigger signal for causing the pulsed light emission in the pump light source 11, and, based on the above, may generate the trigger signal for indicating the start timing of the voltage sweep at the sweep electrode of the streak camera 17.

Further, the timing generation unit 18 may generate both the trigger signal for indicating the timing of the pulsed light emission by the pump light source 11 and the trigger signal for indicating the start timing of the voltage sweep at the sweep electrode of the streak camera 17. In the case in which the probe light source 14 outputs the pulsed light as the probe light, the timing generation unit 18 may generate the trigger signal for indicating the timing of the pulsed light emission by the probe light source 14.

The analysis unit 19 performs the spectroscopic measurement of the sample S based on the temporal waveforms of the respective intensities of the first polarized light component and the second polarized light component of the probe light and of the pump light detected by the streak camera 17. Specifically, the analysis unit 19 obtains, out of the temporal waveform of the intensity of each of the first polarized light component and the second polarized light component of the probe light, a temporal waveform in a period including a time at which the pump light is detected.

By calculating the difference between the above temporal waveforms, the temporal waveform of the electric field of the terahertz wave which is input to the terahertz wave detection element 13 is determined. By performing Fourier transform on the above temporal waveform of the electric field of the terahertz wave, an amplitude spectrum and a phase spectrum of the electric field of the terahertz wave are obtained. Based on the amplitude spectra and the phase spectra respectively obtained when the sample S is not provided on the optical path of the terahertz wave and when the sample S is inserted, the spectroscopic measurement of the sample S can be performed.

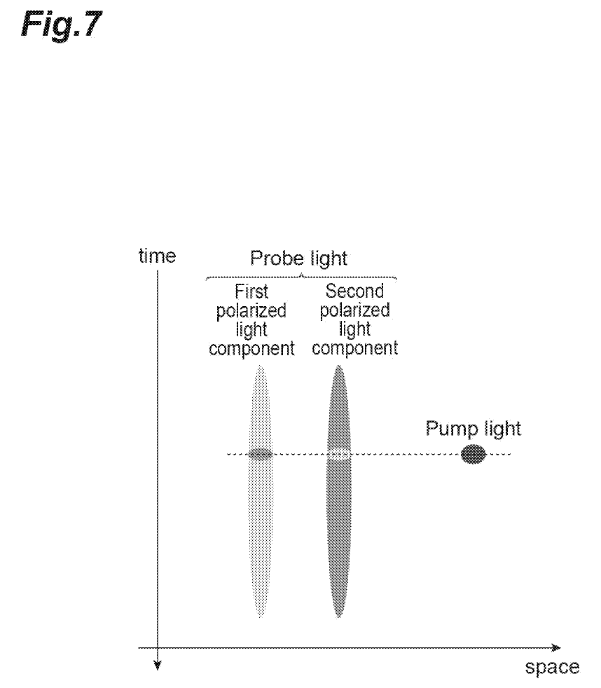

FIG. 7 is a diagram schematically illustrating the phosphor image which is displayed on the phosphor screen of the streak camera 17. In the phosphor image illustrated in this diagram, the horizontal direction corresponds to the spatial axis of the longitudinal direction of the slit of the streak camera 17, and the vertical direction corresponds to the temporal axis.

In the case in which the first polarized light component and the second polarized light component of the probe light and the pump light are input to the positions different from each other in the longitudinal direction of the slit of the streak camera 17, the phosphor images of the temporal waveforms of the intensities of the above light beams are displayed separated from each other on the phosphor screen of the streak camera 17. The analysis unit 19, for each of the first polarized light component and the second polarized light component of the probe light and the pump light, acquires numerical data of the temporal waveform of the intensity based on the phosphor image, and performs calculation by using the numerical data.

The analysis unit 19 may perform the spectroscopic measurement of the sample S, for each single pulse of the pump light, based on the temporal waveform of the intensity of each of the first polarized light component and the second polarized light component of the probe light. Further, the analysis unit 19 may also, for each of a plurality of pulses of the pump light, obtain the numerical data of the temporal waveform of the intensity of each of the first polarized light component and the second polarized light component of the probe light and of the pump light, add the numerical data of the temporal waveforms of the intensity of each of the first polarized light component and the second polarized light component of the probe light such that the times at which the pump light is detected coincide, and perform the spectroscopic measurement of the sample S based on the addition result.

An adjustment method for an optical system of the terahertz wave spectroscopic measurement apparatus 1 is as follows. In the optical system adjustment, the sample S need not be inserted on the optical path of the terahertz wave. First, the pump light output from the pump light source 11 is input to the streak camera 17 sequentially via the terahertz wave generation element 12, the beam separating mirror 21, and the mirrors 25 to 27, and the optical system including the above optical components is adjusted such that the phosphor image is obtained by the streak camera 17 at this time.

Next, the probe light output from the probe light source 14 is input to the terahertz wave detection element 13 via the beam combining mirror 22, and the optical system including the above optical components is adjusted such that the probe light becomes coaxial with the terahertz wave (or, in the case in which a part of the pump light is input to the terahertz wave detection element 13, becomes coaxial with the pump light) at this time.

Next, the probe light output from the probe light source 14 is input to the streak camera 17 sequentially via the beam combining mirror 22, the terahertz wave detection element 13, the beam separating mirror 23, the quarter wave plate 15, the mirror 24, and the polarizing beam splitter 16, and the optical system including the above optical components is adjusted such that the phosphor image is obtained by the streak camera 17 at this time.

A terahertz wave spectroscopic measurement method performed by using the terahertz wave spectroscopic measurement apparatus 1 is as follows. The pump light output from the pump light source 11 is input to the terahertz wave generation element 12, and the terahertz wave is generated by the terahertz wave generation element 12 (a terahertz wave generation step).

The terahertz wave output from the terahertz wave generation element 12 and passed through the sample S is input to the terahertz wave detection element 13, and further, the probe light output from the probe light source 14 is input to the terahertz wave detection element 13, and the probe light which is polarization modulated according to the electric field of the terahertz wave by the terahertz wave detection element 13 is output (a modulation step).

The probe light output from the terahertz wave detection element 13 and passed through the quarter wave plate 15 is split by the polarizing beam splitter 16 into the first polarized light component and the second polarized light component orthogonal to each other (a polarized light splitting step). The temporal waveforms of the respective intensities of the first polarized light component and the second polarized light component of the probe light and of the pump light are detected by the streak camera 17 (a temporal waveform detection step).

Further, the spectroscopic measurement of the sample S is performed based on, out of the temporal waveform of the intensity of each of the first polarized light component and the second polarized light component of the probe light detected by the streak camera 17, the temporal waveform in the period including the time at which the pump light is detected by the streak camera 17 (an analysis step).

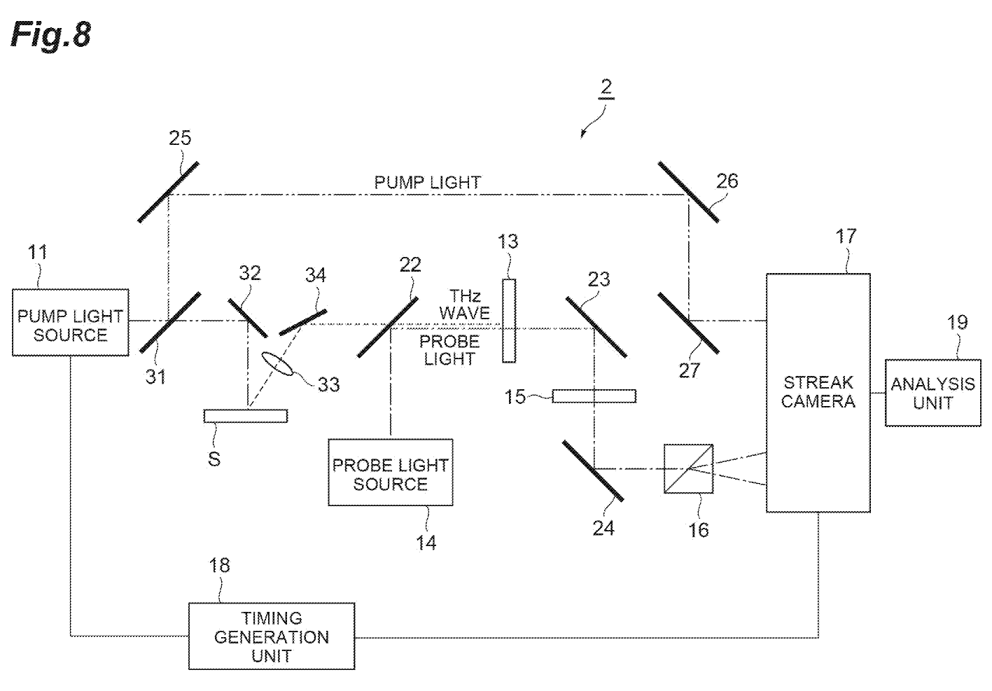

Next, a second embodiment will be described. FIG. 8 is a diagram illustrating a configuration of a terahertz wave spectroscopic measurement apparatus 2 according to a second embodiment. As compared with the terahertz wave spectroscopic measurement apparatus 1 of the first embodiment (FIG. 6), the terahertz wave spectroscopic measurement apparatus 2 of the second embodiment (FIG. 8) is different in that, instead of generating the terahertz wave by causing the pump light to be incident on the terahertz wave generation element 12, the sample S is irradiated with the pump light, and the terahertz wave is generated when the sample S is processed, and different in that the spectroscopic measurement of the sample S is performed during the processing to monitor a processing status of the sample S. In the following description, the differences will mainly be described.

The pump light output from the pump light source 11 is split into two light beams by a beam splitter 31, a part of the pump light is reflected to the mirror 25, and a remaining part is transmitted through the beam splitter 31. The pump light transmitted through the beam splitter 31 is reflected by a mirror 32, and the sample S is irradiated with the pump light.

By irradiating the sample S with the pump light, the sample S is processed, and the terahertz wave is generated during the above processing. The terahertz wave generated at the sample S during the processing is collimated by a lens 33, reflected by a mirror 34, and input to the beam combining mirror 22.

The beam combining mirror 22 inputs the terahertz wave arriving from the sample S via the lens 33 and the mirror 34, and transmits the terahertz wave to the terahertz wave detection element 13, and further, inputs the probe light output from the probe light source 14, and reflects the probe light to the terahertz wave detection element 13. The terahertz wave and the probe light output from the beam combining mirror 22 and input to the terahertz wave detection element 13 are made coaxial.

The analysis unit 19 performs the spectroscopic measurement of the sample S during the processing and monitors the processing status of the sample S based on the temporal waveforms of the respective intensities of the first polarized light component and the second polarized light component of the probe light and of the pump light detected by the streak camera 17. Specifically, the analysis unit 19 obtains, out of the temporal waveform of the intensity of each of the first polarized light component and the second polarized light component of the probe light, the temporal waveform in the period including the time at which the pump light is detected.

By calculating the difference between the above temporal waveforms, the temporal waveform of the electric field of the terahertz wave which is input to the terahertz wave detection element 13 is determined. By performing Fourier transform on the above temporal waveform of the electric field of the terahertz wave, the amplitude spectrum and the phase spectrum of the electric field of the terahertz wave are obtained. Based on the amplitude spectrum and the phase spectrum, the spectroscopic measurement of the sample S during the processing can be performed, and the processing status of the sample S can be monitored.

The terahertz wave spectroscopic measurement method performed by using the terahertz wave spectroscopic measurement apparatus 2 is as follows. The sample S is irradiated with the pump light output from the pump light source 11, and the terahertz wave is generated when the sample S is processed (the terahertz wave generation step).

The terahertz wave is input to the terahertz wave detection element 13, and further, the probe light output from the probe light source 14 is input to the terahertz wave detection element 13, and the probe light which is polarization modulated according to the electric field of the terahertz wave by the terahertz wave detection element 13 is output (the modulation step).

The probe light output from the terahertz wave detection element 13 and passed through the quarter wave plate 15 is split by the polarizing beam splitter 16 into the first polarized light component and the second polarized light component orthogonal to each other (the polarized light splitting step). The temporal waveforms of the respective intensities of the first polarized light component and the second polarized light component of the probe light and of the pump light are detected by the streak camera 17 (the temporal waveform detection step).

Further, the spectroscopic measurement of the sample S is performed based on, out of the temporal waveform of the intensity of each of the first polarized light component and the second polarized light component of the probe light detected by the streak camera 17, the temporal waveform in the period including the time at which the pump light is detected by the streak camera 17, and the processing status of the sample S is monitored (the analysis step).

The generation of the terahertz wave in the sample when the sample is processed by the pulsed light irradiation is described in Non Patent Document 3. By determining the respective spectra of the amplitude and the phase of the terahertz wave (in particular, a carrier envelope phase), the state of the sample during the processing can be monitored in real time. As state change of the sample, for example, electron transport dynamics, electron emission from the sample, and the like can be evaluated. As a result, monitoring of shape change of the sample, monitoring of material change due to electron change of the sample, and the like become possible.

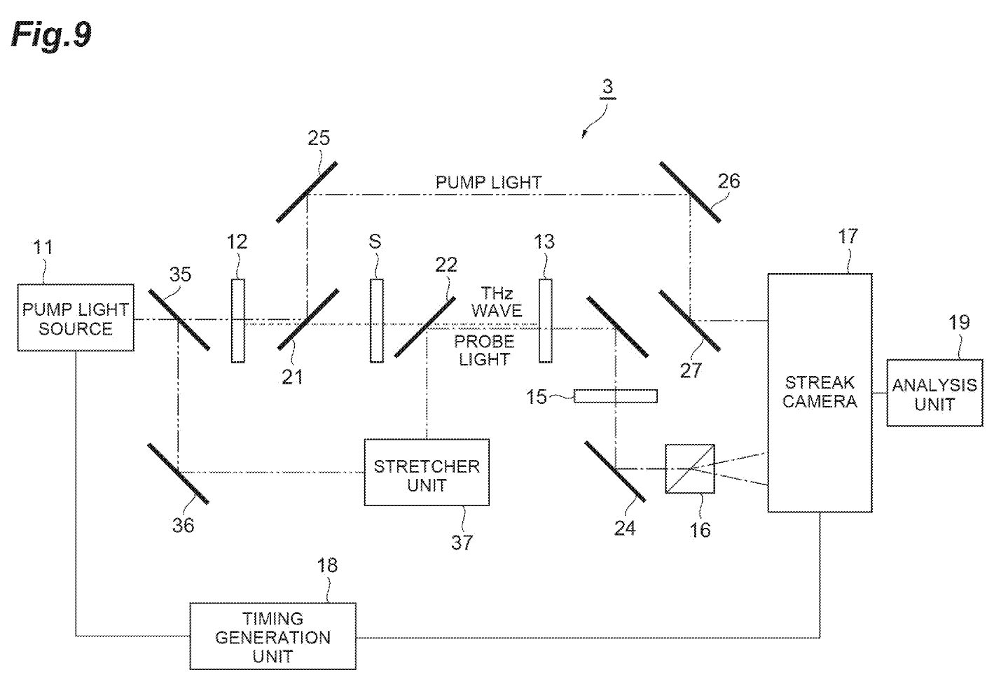

Next, a third embodiment will be described. FIG. 9 is a diagram illustrating a configuration of a terahertz wave spectroscopic measurement apparatus 3 according to a third embodiment. As compared with the terahertz wave spectroscopic measurement apparatus 1 of the first embodiment (FIG. 6), the terahertz wave spectroscopic measurement apparatus 3 of the third embodiment (FIG. 9) is different in that the apparatus includes a beam splitter 35 and a mirror 36, and different in that the apparatus includes a stretcher unit 37 instead of the probe light source 14. In the following description, the differences will mainly be described.

The pump light output from the pump light source 11 is split into two light beams by the beam splitter 35, a part of the pump light is reflected to the mirror 36, and a remaining part is transmitted to the terahertz wave generation element 12. The pump light reflected by the beam splitter 35 is reflected by the mirror 36, and then input to the stretcher unit 37.

The stretcher unit 37 stretches the pulse width of the input pump light to generate the probe light, and outputs the probe light to the beam combining mirror 22. The stretcher unit 37 can stretch the pulse width by using, for example, a configuration including a diffraction grating. In the above configuration, the stretcher unit 37 stretches the pulse width of the probe light, and any one of the optical path lengths is adjusted, such that the probe light is input to the terahertz wave detection element 13 over the input period of the terahertz wave.

The terahertz wave spectroscopic measurement method performed by using the terahertz wave spectroscopic measurement apparatus 3 is as follows. The pump light output from the pump light source 11 is input to the terahertz wave generation element 12, and the terahertz wave is generated by the terahertz wave generation element 12 (the terahertz wave generation step).

The pulse width of the pump light output from the pump light source 11 is stretched by the stretcher unit 37 to generate the probe light (a stretching step). The terahertz wave output from the terahertz wave generation element 12 and passed through the sample S is input to the terahertz wave detection element 13, and further, the probe light output from the stretcher unit 37 is input to the terahertz wave detection element 13, and the probe light which is polarization modulated according to the electric field of the terahertz wave by the terahertz wave detection element 13 is output (the modulation step).

The probe light output from the terahertz wave detection element 13 and passed through the quarter wave plate 15 is split by the polarizing beam splitter 16 into the first polarized light component and the second polarized light component orthogonal to each other (the polarized light splitting step). The temporal waveforms of the respective intensities of the first polarized light component and the second polarized light component of the probe light and of the pump light are detected by the streak camera 17 (the temporal waveform detection step).

Further, the spectroscopic measurement of the sample S is performed based on, out of the temporal waveform of the intensity of each of the first polarized light component and the second polarized light component of the probe light detected by the streak camera 17, the temporal waveform in the period including the time at which the pump light is detected by the streak camera 17 (the analysis step).

As described above, in the present embodiment, scanning of the timing and use of the lock-in amplifier, which are necessary in the conventional THz-TDS, are not necessary, and thus, the spectroscopic measurement of the sample by using the terahertz wave can be performed in a short time. Further, it is also possible to perform the spectroscopic measurement of the sample based on the temporal waveforms of the respective intensities of the first polarized light component and the second polarized light component of the probe light for the single pulse of the pump light, and thus, the measurement can be performed in an even shorter time.

Further, in the present embodiment, the streak camera detects the temporal waveforms of the respective intensities of the first polarized light component and the second polarized light component of the probe light output from the polarizing beam splitter 16, and in addition, detects the temporal waveform of the intensity of the pump light. By using the above configuration, even when there is jitter in the pump light source 11 and the like, based on the detection timing of the pump light, the temporal waveform corresponding to the main pulse out of the temporal waveforms of the intensity of each of the first polarized light component and the second polarized light component of the probe light can be acquired, and thus, the spectroscopic measurement can be performed more accurately.

The terahertz wave spectroscopic measurement apparatus and the terahertz wave spectroscopic measurement method are not limited to the embodiments and configuration examples described above, and various modifications are possible.

The terahertz wave spectroscopic measurement apparatus of a first aspect according to the above embodiment includes (1) a pump light source configured to output pulsed light as pump light; (2) a terahertz wave generation element configured to input the pump light, and generate a terahertz wave; (3) a terahertz wave detection element configured to input the terahertz wave passed through a sample, input probe light over an input period of the terahertz wave, and output the probe light which is polarization modulated according to an electric field of the terahertz wave; (4) a quarter wave plate configured to change a polarization state of the probe light output from the terahertz wave detection element; (5) a polarizing beam splitter configured to split the probe light output from the quarter wave plate into a first polarized light component and a second polarized light component orthogonal to each other; (6) a streak camera configured to detect temporal waveforms of respective intensities of the first polarized light component and the second polarized light component of the probe light output from the polarizing beam splitter and of the pump light; and (7) an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

The terahertz wave spectroscopic measurement apparatus of a second aspect according to the above embodiment includes (1) a pump light source configured to output pulsed light as pump light; (2) a terahertz wave detection element configured to input a terahertz wave generated when a sample is processed by irradiating the sample with the pump light, input probe light over an input period of the terahertz wave, and output the probe light which is polarization modulated according to an electric field of the terahertz wave; (3) a quarter wave plate configured to change a polarization state of the probe light output from the terahertz wave detection element; (4) a polarizing beam splitter configured to split the probe light output from the quarter wave plate into a first polarized light component and a second polarized light component orthogonal to each other; (5) a streak camera configured to detect temporal waveforms of respective intensities of the first polarized light component and the second polarized light component of the probe light output from the polarizing beam splitter and of the pump light; and (6) an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitor a processing status of the sample.

In the terahertz wave spectroscopic measurement apparatus of a third aspect, in the configuration of the first or second aspect, the analysis unit may be configured to perform the spectroscopic measurement of the sample for a single pulse of the pump light based on the temporal waveform of the intensity of each of the first polarized light component and the second polarized light component of the probe light detected by the streak camera.

In the terahertz wave spectroscopic measurement apparatus of a fourth aspect, in the configuration of any one of the first to third aspects, the apparatus may further include a stretcher unit configured to stretch a pulse width of the pump light to generate the probe light.

In the terahertz wave spectroscopic measurement apparatus of a fifth aspect, in the configuration of any one of the first to third aspects, the apparatus may further include a probe light source configured to output the probe light.

In the terahertz wave spectroscopic measurement apparatus of a sixth aspect, in the configuration of the fifth aspect, the probe light source may be configured to output CW light as the probe light.

The terahertz wave spectroscopic measurement method of a first aspect according to the above embodiment includes (1) a terahertz wave generation step of inputting pulsed light output as pump light from a pump light source to a terahertz wave generation element, and generating a terahertz wave by the terahertz wave generation element; (2) a modulation step of inputting the terahertz wave passed through a sample to a terahertz wave detection element, inputting probe light to the terahertz wave detection element over an input period of the terahertz wave, and outputting the probe light which is polarization modulated according to an electric field of the terahertz wave by the terahertz wave detection element; (3) a polarized light splitting step of splitting, by a polarizing beam splitter, the probe light output from the terahertz wave detection element and passed through a quarter wave plate into a first polarized light component and a second polarized light component orthogonal to each other; (4) a temporal waveform detection step of detecting, by a streak camera, temporal waveforms of respective intensities of the first polarized light component and the second polarized light component of the probe light output from the polarizing beam splitter and of the pump light; and (5) an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

The terahertz wave spectroscopic measurement method of a second aspect according to the above embodiment includes (1) a terahertz wave generation step of irradiating a sample with pulsed light output as pump light from a pump light source, and generating a terahertz wave when the sample is processed; (2) a modulation step of inputting the terahertz wave to a terahertz wave detection element, inputting probe light to the terahertz wave detection element over an input period of the terahertz wave, and outputting the probe light which is polarization modulated according to an electric field of the terahertz wave by the terahertz wave detection element; (3) a polarized light splitting step of splitting, by a polarizing beam splitter, the probe light output from the terahertz wave detection element and passed through a quarter wave plate into a first polarized light component and a second polarized light component orthogonal to each other; (4) a temporal waveform detection step of detecting, by a streak camera, temporal waveforms of respective intensities of the first polarized light component and the second polarized light component of the probe light output from the polarizing beam splitter and of the pump light; and (5) an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitoring a processing status of the sample.

In the terahertz wave spectroscopic measurement method of a third aspect, in the configuration of the first or second aspect, in the analysis step, the spectroscopic measurement of the sample may be performed for a single pulse of the pump light based on the temporal waveform of the intensity of each of the first polarized light component and the second polarized light component of the probe light detected by the streak camera.

In the terahertz wave spectroscopic measurement method of a fourth aspect, in the configuration of any one of the first to third aspects, the method may further include a stretching step of stretching a pulse width of the pump light to generate the probe light.

In the terahertz wave spectroscopic measurement method of a fifth aspect, in the configuration of any one of the first to third aspects, in the modulation step, the probe light output from a probe light source may be input to the terahertz wave detection element.

In the terahertz wave spectroscopic measurement method of a sixth aspect, in the configuration of the fifth aspect, in the modulation step, CW light output as the probe light from the probe light source may be input to the terahertz wave detection element.

The present invention can be used as a terahertz wave spectroscopic measurement apparatus and a terahertz wave spectroscopic measurement method capable of performing spectroscopic measurement of a sample by using a terahertz wave in a short time.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A terahertz wave spectroscopic measurement apparatus comprising:
a pump light source configured to output pulsed light as pump light;
a terahertz wave generation element configured to input the pump light, and generate a terahertz wave;
a terahertz wave detection element configured to input the terahertz wave passed through a sample, input probe light over an input period of the terahertz wave, and output the probe light with polarization modulation according to an electric field of the terahertz wave;
a quarter wave plate configured to change a polarization state of the probe light output from the terahertz wave detection element;
a polarizing beam splitter configured to split the probe light output from the quarter wave plate into a first polarized light component and a second polarized light component orthogonal to each other;
a streak camera configured to detect temporal waveforms of respective intensities of the first polarized light component and the second polarized light component of the probe light output from the polarizing beam splitter and of the pump light; and
an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

2. The terahertz wave spectroscopic measurement apparatus according to claim 1, wherein the analysis unit is configured to perform the spectroscopic measurement of the sample for a single pulse of the pump light based on the temporal waveform of the intensity of each of the first polarized light component and the second polarized light component of the probe light detected by the streak camera.

3. The terahertz wave spectroscopic measurement apparatus according to claim 1, further comprising a stretcher unit configured to stretch a pulse width of the pump light to generate the probe light.

4. The terahertz wave spectroscopic measurement apparatus according to claim 1, further comprising a probe light source configured to output the probe light.

5. The terahertz wave spectroscopic measurement apparatus according to claim 4, wherein the probe light source is configured to output CW light as the probe light.

6. A terahertz wave spectroscopic measurement apparatus comprising:
a pump light source configured to output pulsed light as pump light;
a terahertz wave detection element configured to input a terahertz wave generated when a sample is processed by irradiating the sample with the pump light, input probe light over an input period of the terahertz wave, and output the probe light with polarization modulation according to an electric field of the terahertz wave;
a quarter wave plate configured to change a polarization state of the probe light output from the terahertz wave detection element;
a polarizing beam splitter configured to split the probe light output from the quarter wave plate into a first polarized light component and a second polarized light component orthogonal to each other;
a streak camera configured to detect temporal waveforms of respective intensities of the first polarized light component and the second polarized light component of the probe light output from the polarizing beam splitter and of the pump light; and
an analysis unit configured to perform spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitor a processing status of the sample.

7. The terahertz wave spectroscopic measurement apparatus according to claim 6, wherein the analysis unit is configured to perform the spectroscopic measurement of the sample for a single pulse of the pump light based on the temporal waveform of the intensity of each of the first polarized light component and the second polarized light component of the probe light detected by the streak camera.

8. The terahertz wave spectroscopic measurement apparatus according to claim 6, further comprising a stretcher unit configured to stretch a pulse width of the pump light to generate the probe light.

9. The terahertz wave spectroscopic measurement apparatus according to claim 6, further comprising a probe light source configured to output the probe light.

10. The terahertz wave spectroscopic measurement apparatus according to claim 9, wherein the probe light source is configured to output CW light as the probe light.

11. A terahertz wave spectroscopic measurement method comprising:
a terahertz wave generation step of inputting pulsed light output as pump light from a pump light source to a terahertz wave generation element, and generating a terahertz wave by the terahertz wave generation element;
a modulation step of inputting the terahertz wave passed through a sample to a terahertz wave detection element, inputting probe light to the terahertz wave detection element over an input period of the terahertz wave, and outputting the probe light with polarization modulation according to an electric field of the terahertz wave by the terahertz wave detection element;
a polarized light splitting step of splitting, by a polarizing beam splitter, the probe light output from the terahertz wave detection element and passed through a quarter wave plate into a first polarized light component and a second polarized light component orthogonal to each other;
a temporal waveform detection step of detecting, by a streak camera, temporal waveforms of respective intensities of the first polarized light component and the second polarized light component of the probe light output from the polarizing beam splitter and of the pump light; and
an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera.

12. The terahertz wave spectroscopic measurement method according to claim 11, wherein in the analysis step, the spectroscopic measurement of the sample is performed for a single pulse of the pump light based on the temporal waveform of the intensity of each of the first polarized light component and the second polarized light component of the probe light detected by the streak camera.

13. The terahertz wave spectroscopic measurement method according to claim 11, further comprising a stretching step of stretching a pulse width of the pump light to generate the probe light.

14. The terahertz wave spectroscopic measurement method according to claim 11, wherein in the modulation step, the probe light output from a probe light source is input to the terahertz wave detection element.

15. The terahertz wave spectroscopic measurement method according to claim 14, wherein in the modulation step, CW light output as the probe light from the probe light source is input to the terahertz wave detection element.

16. A terahertz wave spectroscopic measurement method comprising:
a terahertz wave generation step of irradiating a sample with pulsed light output as pump light from a pump light source, and generating a terahertz wave when the sample is processed;
a modulation step of inputting the terahertz wave to a terahertz wave detection element, inputting probe light to the terahertz wave detection element over an input period of the terahertz wave, and outputting the probe light with polarization modulation according to an electric field of the terahertz wave by the terahertz wave detection element;
a polarized light splitting step of splitting, by a polarizing beam splitter, the probe light output from the terahertz wave detection element and passed through a quarter wave plate into a first polarized light component and a second polarized light component orthogonal to each other;
a temporal waveform detection step of detecting, by a streak camera, temporal waveforms of respective intensities of the first polarized light component and the second polarized light component of the probe light output from the polarizing beam splitter and of the pump light; and
an analysis step of performing spectroscopic measurement of the sample based on, out of the temporal waveform of the intensity of each of the first polarized light component and the second polarized light component of the probe light detected by the streak camera, a temporal waveform in a period including a time at which the pump light is detected by the streak camera, and monitoring a processing status of the sample.

17. The terahertz wave spectroscopic measurement method according to claim 16, wherein in the analysis step, the spectroscopic measurement of the sample is performed for a single pulse of the pump light based on the temporal waveform of the intensity of each of the first polarized light component and the second polarized light component of the probe light detected by the streak camera.

18. The terahertz wave spectroscopic measurement method according to claim 16, further comprising a stretching step of stretching a pulse width of the pump light to generate the probe light.

19. The terahertz wave spectroscopic measurement method according to claim 16, wherein in the modulation step, the probe light output from a probe light source is input to the terahertz wave detection element.

20. The terahertz wave spectroscopic measurement method according to claim 19, wherein in the modulation step, CW light output as the probe light from the probe light source is input to the terahertz wave detection element.
